(19) United States
(12) Patent Application Publication
(10) Pub. No.: US 2007/0125473 A1
(43) Pub. Date: Jun. 7, 2007

(54) FILM ATTACHING METHOD AND SCREEN OF REAR PROJECTION TELEVISION

(75) Inventors: Jaw-Ji Chen, Hsinchu (TW); Han-Jung Chen, Hsinchu (TW); Chien-Ming Huang, Hsinchu (TW)

Correspondence Address: J C PATENTS, INC., 4 VENTURE, SUITE 250, IRVINE, CA, 92618, US

(73) Assignee: NANO PRECISION CORPORATION, Hsinchu (TW)

(21) Appl. No.: 11/551,373

(22) Filed: Oct. 20, 2006

(30) Foreign Application Priority Data
Dec. 7, 2005 (TW) 94143099

(51) Int. Cl. B31B 1/60

(52) U.S. Cl. 156/60

(57) ABSTRACT

A film attaching method for attaching a film on a substrate is provided. The film attaching method includes the following steps. First, a film is disposed on the substrate. Then, gas between the film and the substrate is driven out. Ultimately, an airtight joint is formed between the edge of the film and the edge of the substrate so that the film is attached to the substrate. The film attaching method is applied to the screen of a rear projection television to provide the rear projection television with good optical characteristics.

### CROSS-REFERENCE TO RELATED APPLICATION

This application claims the priority benefit of Taiwan application serial no. 94143099, filed on Dec. 7, 2005. All disclosure of the Taiwan application is incorporated herein by reference.

### BACKGROUND OF THE INVENTION

1. Field of the Invention

The present invention relates to a film, and more particularly, to a film attaching method and a screen of a rear projection television using the film attaching method.

2. Description of Related Art

A screen of a conventional rear projection television includes a Fresnel lens film and a lenticular lens film attached with the Fresnel lens film. In the conventional film attaching process, an adhesive is globally coated on the lenticular lens film and then the Fresnel lens film is attached to the lenticular lens film. However, the process of coating the adhesive on the lenticular lens film is time-consuming. Moreover, once there is any misalignment between the Fresnel lens film and the lenticular lens film, the error cannot be remedied by a rework. Hence, the process leads to considerable waste of film material and increases the production cost. In addition, the adhesive between the lenticular lens film and the Fresnel lens film affects the light transmittance and results in poorer optical characteristics for the rear projection television.

### SUMMARY OF THE INVENTION

Accordingly, the present invention is directed to provide a film attaching method that reduces production cost and is easy to rework.

The present invention is directed to provide a screen of a rear projection television that has a lower production cost and is easy to rework.

As embodied and broadly described herein, the invention provides a film attaching method for attaching a film on a substrate. The film attaching method includes following steps. First, the film is disposed on the substrate. Then, gas between the film and the substrate is driven out. Ultimately, an airtight joint is formed between the edge of the film and the edge of the substrate so that the film is attached to the substrate.

The present invention also provides a screen for a rear projection television. The screen includes a substrate and a Fresnel lens film. The Fresnel lens film is directly attached to the substrate. Furthermore, the edge of the film and the edge of the substrate form an airtight joint.

Therefore, the advantages of the film attaching method and the screen of the rear projection television according to the present invention includes simple processing steps that are quick to perform, a low production cost and easy to rework in case of errors.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart showing the steps in a film attaching method according to the present invention.

FIG. 2 is a perspective view showing a film disposed over a substrate according to one embodiment of the present invention.

FIGS. 3 and 4 are schematic cross-sectional views showing a film attaching to a substrate according to one embodiment of the present invention.

FIG. 5 is a diagram showing a film and a substrate disposed inside a gas-extracting chamber.

FIG. 6 is a schematic cross-sectional view showing the process of disposing a film on a substrate according to another embodiment of the present invention.

FIG. 7 is a diagram showing the thermal expansion of a film according to another embodiment of the present invention.

FIG. 8 is a diagram showing the contraction of a substrate by lowering the temperature according to another embodiment of the present invention.

FIG. 9 is a diagram showing the thermal expansion of a film due to heating and the contraction of a substrate due to a lowering of the temperature according to another embodiment of the present invention.

FIG. 10 is a schematic cross-sectional view showing the formation of an airtight joint between a film and a substrate according to another embodiment of the present invention.

FIG. 11 is a schematic cross-sectional view of a screen of a rear projection television using the film attaching method of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

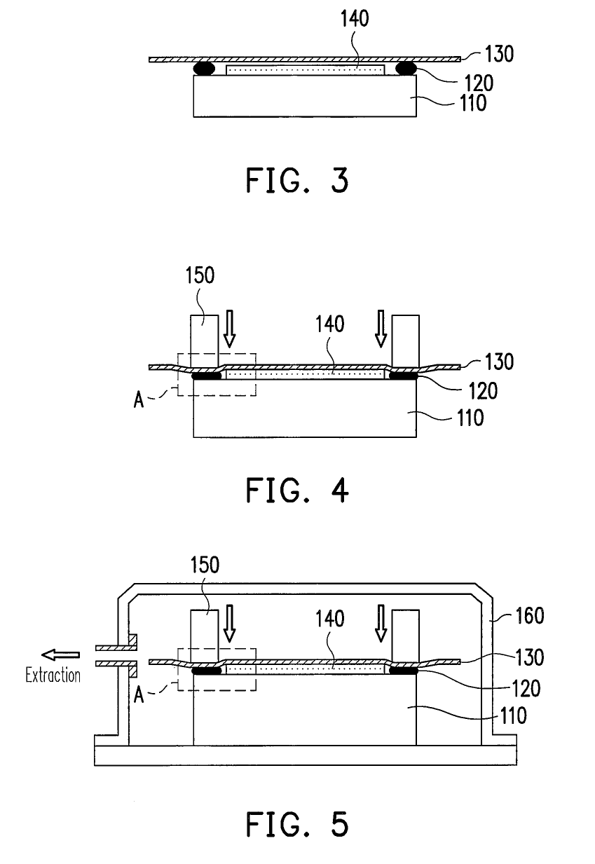

First, as shown in FIGS. 1, 2 and 3, a substrate 110 is provided. Then, an adhesive 120 is coated near the edge of the substrate 110. After aligning a film 130 with the substrate 110, the film 130 is disposed on the substrate 110 in step S110. According to the actual design requirements, another film 140 such as an optical film is also disposed between the substrate 110 and the film 130. The adhesive 120 is, for example, thermal plastic adhesive, thermal plastic tape, ultraviolet hardening adhesive or pressure-sensitive adhesive.

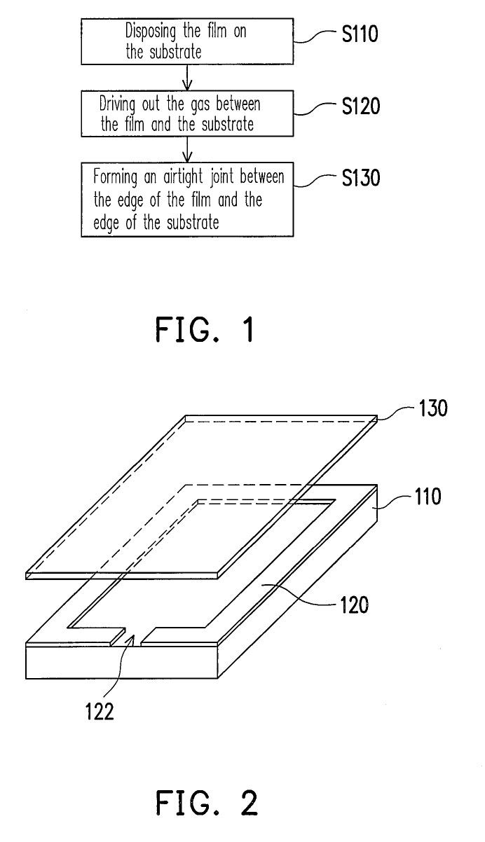

Next, gas between the film 130 and the substrate 100 is driven out in step S 120. The method of driving the gas between the film 130 and the substrate 110 out includes, for example, reserving an opening 122 when dispensing the adhesive 120 on the substrate 110. Then, a gas-extracting device (not shown) is used to extract the gas between the film 130 and the substrate 100 out as shown in FIG. 2.

As shown in FIG. 4, an airtight joint A is formed between the edge of the film 130 and the edge of the substrate 110 so that the film 130 is attached to the substrate 110 as shown in step S130. The method of forming the airtight joint A includes, for example, heating, pressurizing or simultaneously heating and pressurizing the adhesive 120 with a hot plate 150 so as to solidify the adhesive 120. For example, if the adhesive 120 is ultraviolet hardening adhesive, the ultraviolet hardening adhesive is solidified by irradiating ultraviolet light.

It should be noted that an opening 122 (as shown in FIG. 2) is reserved in the adhesive 120 in the embodiment for extracting gas through a gas-extracting device. In another preferred embodiment, the method of removing the gas between the film 130 and the substrate 110 includes disposing the film 130 and the substrate 110 inside a gas-extracting chamber 160. Then, the pressure within the gas-extracting chamber 160 is less than 1 atmosphere so that the gas between the film 130 and the substrate 100 is driven out. After that, the airtight joint A is formed between the edges of the film 130 and the substrate 110 so that the film 130 is automatically attached to the substrate 110 as shown in FIG. 5.

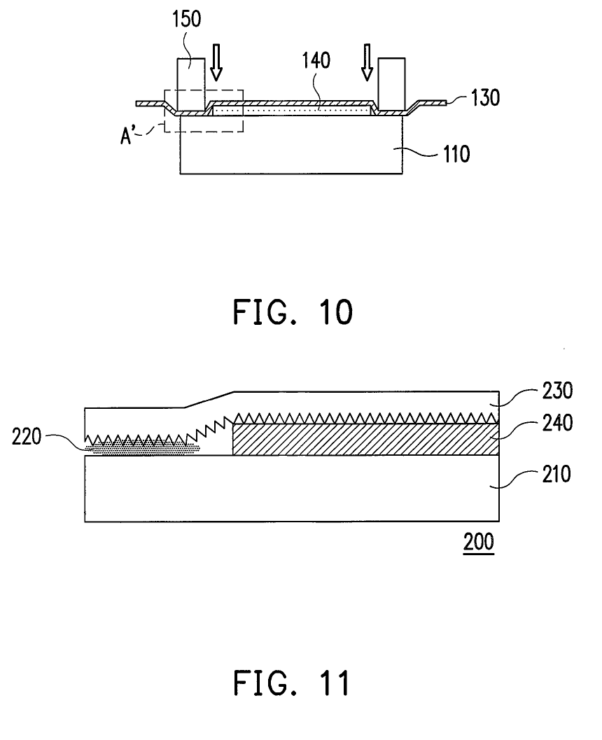

In the present embodiment, the adhesive 120 is disposed between the film 130 and the substrate 110 and then solidified to form the airtight joint A. In an alternative embodiment, there is no need to dispose the adhesive 120 between the film 130 and the substrate 110. Under such condition, the method of forming the airtight joint A between the film 130 and the substrate 110 includes, for example, using a hot plate 150 to fuse the film 130 directly with the substrate 110 (as shown in FIG. 10). Alternatively, ultrasonic welding technique is used to weld the film 130 to the substrate 110. Obviously, the present invention also allows the user to form the airtight joint A between the film 130 and the substrate 110 by mechanical fixing so that the film 130 is automatically attached on the substrate 110.

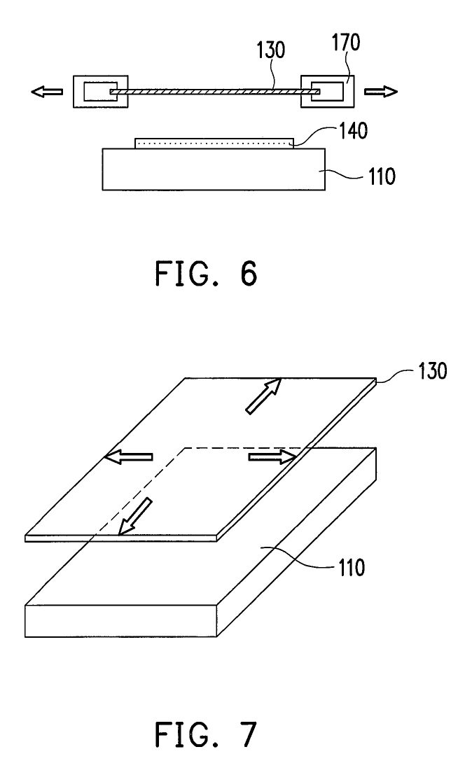

As shown in FIG. 6, before disposing the film 130 on the substrate 110, a tension is applied to the film 130 so that the film 130 is appropriately deformed. Thus, when the film 130 is disposed on the substrate 110, the restoring force of the deformed film 130 smoothly attaches the film 130 to the substrate 110. In the present embodiment, the method of applying the tension to the film 130 includes, for example, using a tensioning device 170 to pull the four sides of the film 130 and the film 130 is deformed in the process.

As shown in FIG. 7, before disposing the film 130 on the substrate 110, the film 130 is heated to make it expand so that a temperature difference is between the film 13O and the substrate 110. Thereafter, the film 130 is attached to the substrate 110. When the film 130 and the substrate 110 return to a normal temperature, a prestressing force exists in the film 130 so that the film 130 is smoothly attached to the substrate 110.

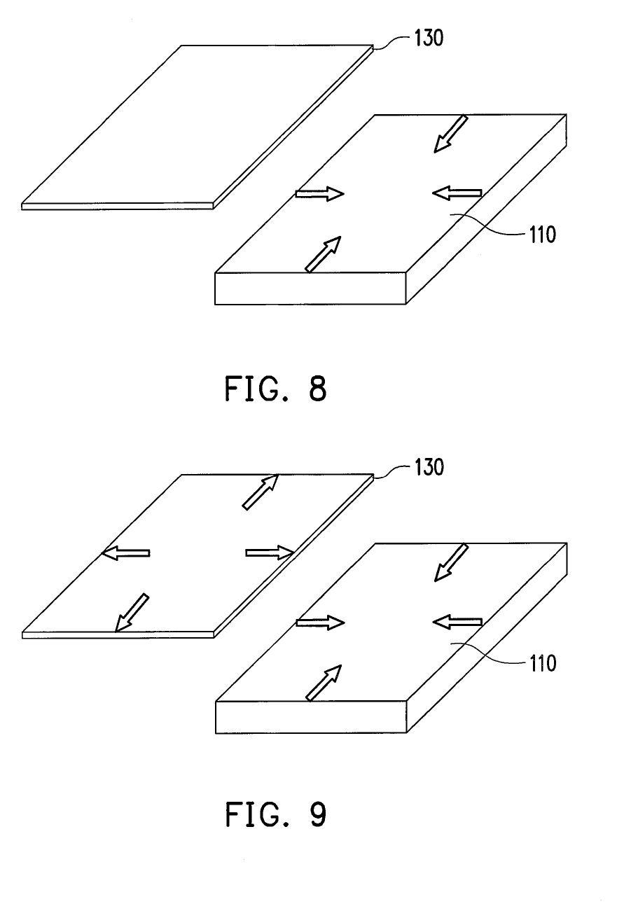

As shown in FIG. 8, before disposing the film 130 on the substrate 110, the temperature of the substrate 110 is lowered to make it contract. When the film 130 is disposed on the substrate 110, the temperature difference between the substrate 110 and the film 130 is utilized to smoothly attach the film 130 on the substrate 110.

As shown in FIG. 9, before disposing the film 130 on the substrate 110, the film 130 is heated to make it expand and the temperature of the substrate 110 is lowered to make it contract. When the film 130 is disposed on the substrate 110, the contraction of the film 130 and the expansion of the substrate 110 are utilized to smoothly attach the film 130 on the substrate 110. In the method shown in FIG. 9, the amplitude of the rise in temperature of the film 130 and the amplitude of the fall in temperature of the substrate 110 is reduced compared with the methods in FIGS. 7 and 8. As a result, the time for raising the temperature of the film 130 and the time for lowering the temperature of the substrate 110 is also reduced.

It should be noted that the physical characteristics such as thickness, ductility and heat resistance of the film 130 and the substrate 110 have to be considered whether the film 130 is deformed through tension or through expansion by heating or the substrate 110 is deformed through contraction by cooling. In general, the film 130 is suitably deformed without disturbing the original characteristics of the film 130.

It should be noted that the film attaching method in the present invention is applied to all kinds of film attaching processes. In particular, the effect is more eminent when the film attaching method is applied to the production of a large size display such as the screen of a rear projection television. However, the film attaching process for fabricating the screen of the rear projection television described in the following is used as an example only and should by no means limit the scope of the present invention.

FIG. 11 is a schematic cross-sectional view of the screen of a rear projection television using the film attaching method of the present invention. In the screen of the rear projection television 200, the film 240 disposed between the film 230 and the substrate 210 is an optical film, for example. The film 230 is a Fresnel lens film and has fine groove patterns on the attachment surface of the substrate 210, for example. Furthermore, the film 230 is attached to the substrate 210 through a solidified adhesive 220, for example. When the film attaching method of the present invention is applied to the screen of a large-size rear projection television, the gas between the film 230 and the substrate 210 is driven out. Since no air bubble is trapped between the film 230 and the substrate 210 when the film 230 is attached to the substrate 210, the surface of film 230 is very smooth. In addition, the film 230 is directly attached to the substrate 210 by heat fusion, ultrasonic welding or mechanical fixing. Therefore, overall thickness of the film 230 attached to the substrate 210 is unaffected almost by the thickness of the adhesive.

Accordingly, the film attaching method of the present invention does not affect the transmittance of the light emitted from the light source through the screen of the rear projection television whether or not the adhesive 220 is present between the film 230 and the substrate 210. Therefore, the screen of the rear projection television has very good optical characteristics.

In summary, the film attaching method in the present invention has the following advantages:
1. The adhesive between the film and the substrate is coated around the edges of the substrate and the film instead of all scope on the substrate. Thus, the processing speed is faster and the adhesive produces less contamination. Moreover, the production cost is lowered and the light transmittance in the final product is unaffected.
2. By tensioning, heating or cooling the film, the film is smoothly attached to the substrate.
3. By driving the gas between the film and the substrate out through a gas extraction, defects caused by air bubbles on the final product are eliminated.
4. The method of the present invention is quite simple and rework is easy.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A film attaching method for attaching a film on a substrate, comprising:
disposing the film on the substrate;
driving out gas between the film and the substrate; and
forming an airtight joint between an edge of the film and an edge of the substrate so that the film is attached to the substrate.

2. The film attaching method of claim 1, wherein a method of forming the airtight joint comprises performing heat fusion or ultrasonic welding or mechanical fixing.

3. The film attaching method of claim 1, wherein a method of forming the airtight joint comprises:
providing an adhesive between the film and the substrate, wherein the adhesive is disposed near the edge of the film and the substrate; and
solidifying the adhesive after driving out the gas between the film and the substrate.

4. The film attaching method of claim 3, wherein the adhesive comprises thermal plastic adhesive, thermal plastic tape, ultraviolet hardening adhesive or pressure-sensitive adhesive.

5. The film attaching method of claim 3, wherein a method of solidifying the adhesive comprises heating, pressurizing or simultaneously heating and pressurizing.

6. The film attaching method of claim 1, wherein a method of driving out the gas between the film and the substrate comprises:
disposing the film and the substrate inside a gas-extracting chamber; and
setting the pressure inside the gas-extracting chamber less than 1 atmosphere.

7. The film attaching method of claim 1, further comprising applying a tension to the film to deform the film before disposing the film on the substrate so that the restoring force of the deformed film causes the film to attach to the substrate when the film is disposed over the substrate.

8. The film attaching method of claim 1, further comprising heating the film before disposing the film on the substrate so that the film expands, and the temperature difference between the film and the substrate causes the film to attach to the substrate when the film is disposed over the substrate.

9. The film attaching method of claim 1, further comprising lowering the temperature of the substrate before disposing the film on the substrate so that the film is attached to the substrate when the film is disposed on the substrate.

10. The film attaching method of claim 1, wherein the step of disposing the film on the substrate further comprises:
providing the substrate;
coating an adhesive near the edge of the substrate;
aligning the film with the substrate; and
disposing the film on the substrate.

11. The film attaching method of claim 10, wherein an opening is reserved when the adhesive is coated near the edge of the substrate so that a gas-extracting device is connected to the opening for extracting the gas between the film and the substrate.

12. A screen of a rear projection television, comprising:
a substrate; and
a Fresnel lens film directly attached to the substrate to form an airtight joint between an edge of the film and an edge of the substrate.

13. The screen of claim 12, further comprising an adhesive disposed between the edge of the film and the edge of the substrate.
